(19) United States
(12) Patent Application Publication
(10) Pub. No.: US 2017/0136873 A1
(43) Pub. Date: May 18, 2017

(54) Urea Tank

(71) Applicant: Caterpillar SARL, Geneva (CH)

(72) Inventor: Yasutoshi Nanyoshi, Setagaya-ku (JP)

(73) Assignee: Caterpillar SARL, Geneva (CH)

(21) Appl. No.: 15/320,103

(22) PCT Filed: Jun. 30, 2015
(86) PCT No.: PCT/EP2015/064854

§ 371 Date: Dec. 19, 2016

(30) Foreign Application Priority Data
Jul. 4, 2014 (JP) 2014-138495

(51) Int. Cl. B60K 15/03; B60K 15/05

(52) U.S. Cl. CPC B60K 15/03006; B60K 15/05; B60K 2015/03309

(57) ABSTRACT

This invention relates to a urea tank having a filler neck, an inlet adapter and a filler cap. While a filler cap is mounted on a filler neck, a locking piece is rotated 135 degrees, and then the filler cap is pulled upward.; as a result, the filler cap is removed from the filler neck along with an inlet adapter. While the filler cap is mounted on the filler neck, the locking piece is rotated 90 degrees, and then the filler cap is pulled upward; as a result, only the filler cap is removed from the filler neck.

### TECHNICAL FIELD

The present invention relates to a urea tank including a cylindrical water supply opening, an adapter inserted and fitted to the water supply opening, and a lid member attached to the water supply opening and the adapter.

### BACKGROUND ART

In vehicles such as a construction vehicle, bus, or truck, a diesel engine is often used as a drive source. Exhaust gas of the diesel engine includes a large amount of nitrogen oxide (NOx) , and many of vehicles mounting the diesel engine are subject to exhaust gas regulations. Therefore, a reduction in the amount of nitrogen oxide within exhaust gas is required for vehicles mounting the diesel engine.

As a technique of cutting the amount of nitrogen oxide within exhaust gas, urea selective catalytic reduction (SCR) system has been known. The urea SCR system cuts the amount of nitrogen oxide within exhaust gas by a reduction reaction of nitrogen oxide within exhaust gas and aqueous urea. Aqueous urea is stored in a urea tank mounted to a vehicle, sucked by a pump, and injected into an exhaust pipe from a urea injection valve connected to the exhaust pipe.

Regarding aqueous urea as a reducing agent of nitrogen oxide, an international standard (ISO 22241-4:2009) relating to a urea supply interface exists. Also, as a domestic standard, Japanese Industrial Standard (JIS K 2247-4:2013) made fit for circumstances in Japan based on (ISO 22241-4:2009) exists.

The standard above describes a water supply nozzle provided to a urea supply machine, a water supply opening (filler neck) of a urea tank to which a water supply nozzle is inserted, an adapter (inlet adapter) installed to a water supply opening, a lid member (filler cap) that closes a water supply opening, and the like.

Also, from the perspective of preventing a fuel oil supply nozzle from being inserted to a water supply opening by error, the standard above specifies that manufacture should be with a predetermined dimension for the outer diameter of a water supply nozzle and the inner diameter of an adapter. Meanwhile, the standard above specifies that an adapter should be detachable from a water supply opening, in order to enable supply of aqueous urea to a urea tank, with a container or the like including a water supply nozzle (hereinafter referred to as “general water supply nozzle”) not manufactured based on the standard above, in a location such as, for example, a construction site that is not installed with a urea supply machine including a water supply nozzle (hereinafter referred to as “dedicated water supply nozzle”) manufactured based on the standard above.

A manufacturer of a vehicle mounting a diesel engine is desired to satisfy the standard above, such as manufacturing a water supply opening, adapter, lid member, and the like of a urea tank with a specified dimension or enabling distinction between both of a dedicated water supply nozzle and a general water supply nozzle, upon employing the urea SCR system to the vehicle. Regarding this point, Patent Document 1 below discloses a structure of a water supply opening of a urea tank that enables distinction between both of a dedicated water supply nozzle and a general water supply nozzle.

In the structure of the water supply opening disclosed in Patent Document 1, an adapter is detachably connected to the water supply opening by an external thread formed on the lower end side at the outer circumferential surface of the adapter being screwed to an internal thread formed on the upper end side at the inner circumferential surface of the water supply opening, and a lid member is detachably connected to the adapter by an internal thread formed at the inner circumferential surface of the lid member being screwed to an external thread formed on the upper end side of the outer circumferential surface of the adapter.

Patent Document 1: Japanese Patent Application Laid-open No. 2010-127201

### DISCLOSURE OF THE INVENTION

However, in the structure of the water supply opening disclosed in Patent Document 1, the connection of the water supply opening and the adapter and the connection of the adapter and the lid member are each made by screwing. Therefore, upon supplying aqueous urea with a general water supply nozzle, the lid member and the adapter need to be locked by a lock member so that the adapter rotates integrally with the lid member, in order to detach the adapter together with the lid member from the water supply opening. Meanwhile, upon supplying aqueous urea with a dedicated water supply nozzle, lock of the lid member and the adapter by the lock member needs to be released so that the adapter does not rotate integrally with the lid member, in order to detach only the lid member from the water supply opening. Thus, with the structure of the water supply opening disclosed in Patent Document 1, lock or release of lock by a lock member needs to be performed upon opening the water supply opening, and it is cumbersome.

The present invention has been made in view of the facts described above, and a main technical task is to provide a urea tank that enables a lid member to be detached easily together with an adapter from a water supply opening of the urea tank and the lid member to be detached easily from the water supply opening and the adapter of the urea tank.

The present invention provides, as a urea tank that achieves the technical task described above, a urea tank including: a cylindrical water supply opening; an adapter inserted and fitted to the water supply opening; and a lid member attached to the water supply opening and the adapter, wherein an inner circumferential surface of the water supply opening is formed with at least a pair of fitting grooves extending in an axial direction from an upper end, and a locking groove extending in a circumferential direction from one of the pair of fitting grooves and extending through the other one of the pair of fitting grooves, the adapter includes a cylindrical insertion fitting wall, an outer circumferential surface of the insertion fitting wall is formed with at least a pair of fitting pieces protruding outward in a radial direction, and the adapter is inserted and fitted to the water supply opening and located below the locking groove by one of the pair of fitting pieces being fitted to one of the pair of fitting grooves and the other one of the pair of fitting pieces being fitted to the other one of the pair of fitting grooves, an inner circumferential surface of the insertion fitting wall is formed with at least one cutout extending in an axial direction from an upper end and an engagement groove extending in a circumferential direction through the cutout, the cutout being aligned with the other one of the pair of fitting pieces in terms of position in a circumferential direction, the lid member includes a lid body including a top surface wall and a cylindrical side wall suspended from a circumferential edge of the top surface wall, and a support column extending downward from the top surface wall, the support column is formed with at least one locking piece protruding outward in a radial direction from an outer circumferential surface and at least one engagement piece protruding outward in the radial direction from the outer circumferential surface and located below the locking piece, the locking piece and the engagement piece being aligned in terms of position in a circumferential direction, the lid member is attached to the water supply opening and the adapter by the locking piece being locked to the locking groove of the water supply opening and the engagement piece being engaged with the engagement groove of the adapter, the lid member is detached from the water supply opening together with the adapter, when the lid member is rotated until the locking piece is located at one of the pair of fitting grooves and then forced upward in a state where the lid member is attached to the water supply opening and the adapter, and the lid member is detached from the water supply opening and the adapter, when the lid member is rotated until the locking piece is located at the other one of the pair of fitting grooves and then forced upward in a state where the lid member is attached to the water supply opening and the adapter.

Preferably, the support column is rotatably connected to the top surface wall. It is suitable if a cylindrical penetration opening is formed in the top surface wall of the lid body, the support column is formed in a cylindrical shape and rotatably inserted to the penetration opening, a tumbler that inhibits rotation of the support column with respect to the penetration opening is arranged between an inner circumferential surface of the penetration opening and the outer circumferential surface of the support column, the support column is formed with a key hole extending downward from an upper end surface, inhibition of relative rotation of the support column by the tumbler is released when a key corresponding to the key hole is inserted to the key hole, and the support column is rotated by a rotating operation of the key. It is favorable that a bottom surface of the top surface wall of the lid body is formed with at least one pair of fitting protrusions protruding downward, and the fitting protrusions are fitted to the fitting grooves of the water supply opening, respectively, in a state where the lid member is attached to the water supply opening and the adapter. It is preferable if rotation inhibiting means for inhibiting relative rotation of the lid member with respect to the water supply opening is arranged between the lid member and the water supply opening, and inhibition of relative rotation of the lid member by the rotation inhibiting means is released by releasing means corresponding to the rotation inhibiting means.

When the lid member is rotated until the locking piece is located at one of the pair of fitting grooves in a state where the lid member is attached to the water supply opening and the adapter in the urea tank provided by the present invention, the locked state of the locking piece and the locking groove is released, while the engaged state of the engagement piece and the engagement groove is held since the engagement piece is not located at the cutout. When the lid member is then forced upward, the locking piece ascends along the fitting groove, while the engaged state of the engagement piece and the engagement groove is held. Therefore, the lid member is detached from the water supply opening together with the adapter. As a result, aqueous urea can be supplied to the urea tank with a general water supply nozzle.

Also, when the lid member is rotated until the locking piece is located at the other one of the pair of fitting grooves in a state where the lid member is attached to the water supply opening and the adapter in the urea tank according to the present invention, the locked state of the locking piece and the locking groove is released, and the engaged state of the engagement piece and the engagement groove is released since the engagement piece is located at the cutout. When the lid member is then forced upward, the locking piece ascends along the fitting groove, and the engagement piece ascends along the cutout. Therefore, the lid member is detached from the water supply opening and the adapter. As a result, the water supply opening is opened in a state where the adapter is inserted and fitted to the water supply opening, and aqueous urea can be supplied to the urea tank with a dedicated water supply nozzle.

Thus, in the urea tank according to the present invention, adjustment of the rotating angle of the lid member upon opening the water supply opening enables the lid member to be detached easily together with the adapter from the water supply opening and the lid member to be detached easily from the water supply opening and the adapter.

### BRIEF DESCRIPTION OF THE DRAWINGS

FIG. 1 is a perspective view of a urea tank in a first embodiment of the present invention.

FIG. 2 is a plan view of a water supply opening.

FIG. 3 is a development view (inner circumferential surface) of the water supply opening.

FIG. 4 is a plan view of an adapter.

FIG. 5 is a development view (inner circumferential surface) of the adapter.

FIG. 6 is a bottom view of a lid body.

FIG. 7 is a sectional view of the lid body when seen from the A-A direction in FIG. 6.

FIG. 8 is a front view of a support column.

FIG. 9 is a bottom view of the support column.

FIG. 10 is a sectional view when the water supply opening is seen from the front, in a state where the adapter is inserted and fitted to the water supply opening and a lid member is attached to the water supply opening and the adapter.

FIG. 11 is a sectional view when seen from the B-B direction in FIG. 10.

FIG. 12 is a sectional view when seen from the C-C direction in FIG. 10.

FIG. 13 is a development view (inner circumferential surface) of the water supply opening, in a state where the adapter is inserted and fitted to the water supply opening and the lid member is attached to the water supply opening and the adapter.

FIG. 14 is a sectional view when a water supply opening is seen from the front, in a state where an adapter is inserted and fitted to the water supply opening of a urea tank in a second embodiment of the present invention and a lid member is attached to the water supply opening and the adapter.

FIG. 15 is a bottom view of an upper part support column.

### BEST MODE FOR CARRYING OUT THE INVENTION

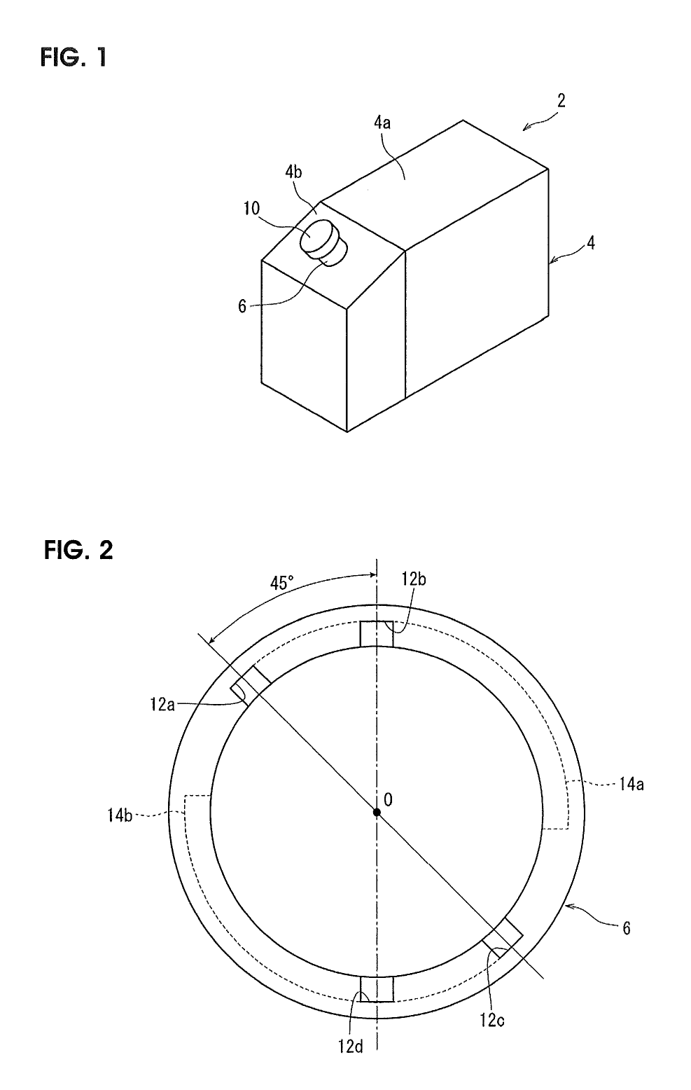

A first embodiment of a urea tank according to the present invention will be described below in detail with reference to the accompanying drawings. FIG. 1 will be referred to and described. A urea tank of which the entirety is shown by number 2 includes a tank body 4 that stores aqueous urea, a water supply opening 6 to which a water supply nozzle is inserted, an adapter 8 inserted and fitted to the water supply opening 6, and a lid member 10 attached to the water supply opening 6 and the adapter 8.

The tank body 4 is formed in a cuboid shape as a whole from an appropriate resin material or stainless steel plate. The upper surface of the tank body 4 includes a horizontal surface 4a extending substantially horizontally and an inclined surface 4b inclined and extending downward toward the side surface on one side from the horizontal surface 4a. The inclined surface 4b is formed with the water supply opening 6. The water supply opening 6 extends cylindrically outward from the tank body 4 to be substantially perpendicular to the inclined surface 4b.

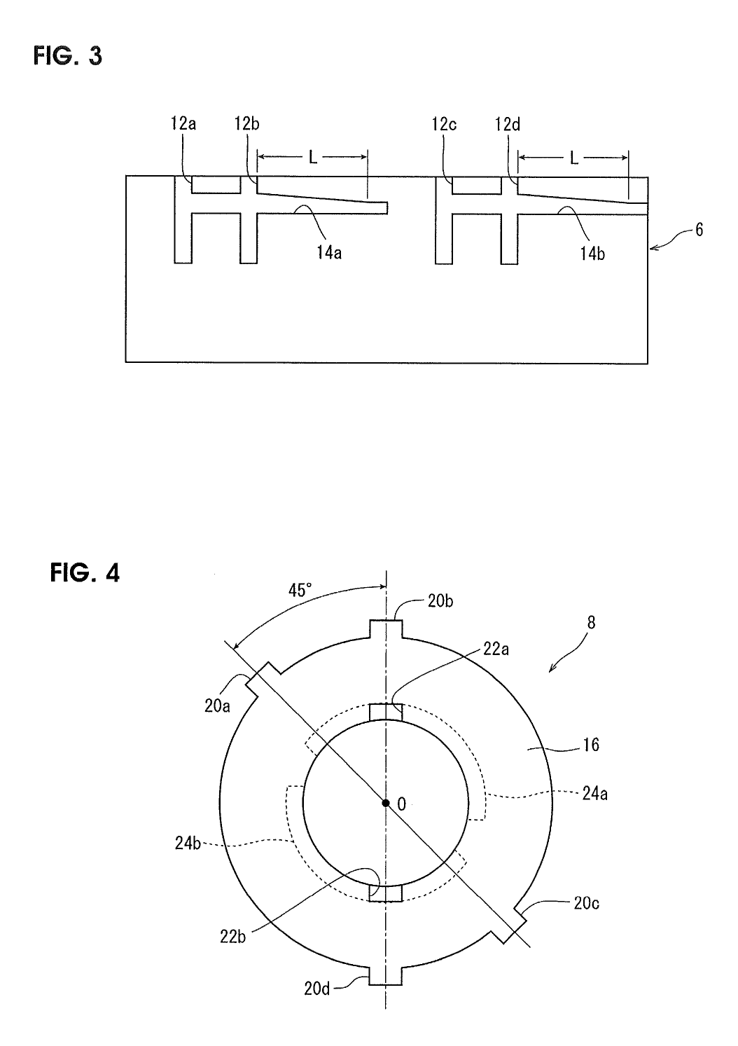

FIG. 2 and FIG. 3 will be referred to and described. The inner circumferential surface of the water supply opening 6 is formed with a pair of fitting grooves 12a and 12b extending in the axial direction from the upper end and a pair of fitting grooves 12c and 12d extending in the axial direction from the upper end in a position opposing the fitting grooves 12a and 12b across a circumferential direction center O. The fitting groove 12a and the fitting groove 12b are apart by 45 degrees in the circumferential direction. Also, the fitting groove 12c and the fitting groove 12d are apart by 45 degrees in the circumferential direction.

Also, the inner circumferential surface of the water supply opening 6 is formed with an arc-shaped locking groove 14a extending to one side in the circumferential direction from the fitting groove 12a and extending through the fitting groove 12b and an arc-shaped locking groove 14b extending to one side in the circumferential direction from the fitting groove 12c and extending through the fitting groove 12d. There is a fan-shaped non-groove part between the base end (fitting groove 12a side) of the locking groove 14a in the circumferential direction and the leading end of the locking groove 14b in the circumferential direction. Also, there is a fan-shaped non-groove part between the base end (fitting groove 12c side) of the locking groove 14b in the circumferential direction and the leading end of the locking groove 14a in the circumferential direction.

The locking groove 14a is formed such that a locking piece 44a described later can rotate 135 degrees in the clockwise direction in the circumferential direction from the fitting groove 12a when seen from above. The upper surface of the locking groove 14a extends perpendicularly to the respective fitting grooves 12a and 12b between the fitting groove 12a and the fitting groove 12b, extends obliquely downward toward the leading end side in the circumferential direction for a predetermined circumferential direction dimension L from the fitting groove 12b, and then extends perpendicularly to the respective fitting grooves 12a and 12b up to the leading end in the circumferential direction. Meanwhile, the bottom surface of the locking groove 14a extends perpendicularly to the respective fitting grooves 12a and 12b up to the leading end from the base end in the circumferential direction.

The locking groove 14b is formed such that a locking piece 44b described later can rotate 135 degrees in the clockwise direction in the circumferential direction from the fitting groove 12c when seen from above. The upper surface of the locking groove 14b extends perpendicularly to the respective fitting grooves 12c and 12d between the fitting groove 12c and the fitting groove 12d, extends obliquely downward toward the leading end side in the circumferential direction for the predetermined circumferential direction dimension L from the fitting groove 12d,and then extends perpendicularly to the respective fitting grooves 12c and 12d up to the leading end in the circumferential direction. Meanwhile, the bottom surface of the locking groove 14b extends perpendicularly to the respective fitting grooves 12c and 12d up to the leading end from the base end in the circumferential direction.

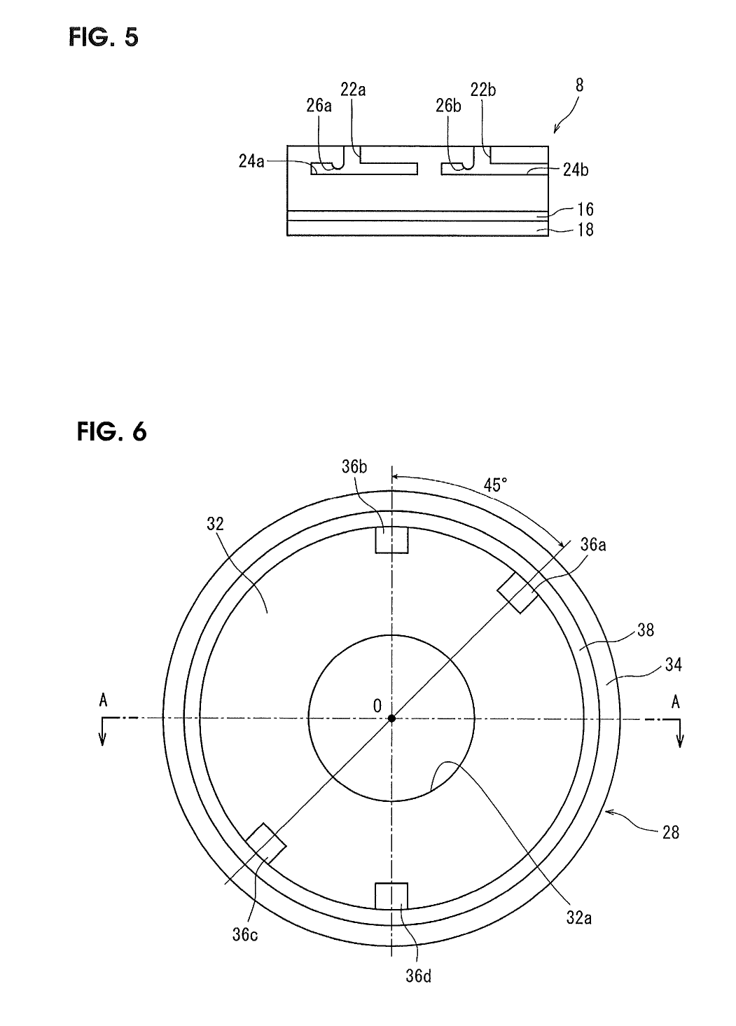

FIG. 4 and FIG. 5 will be referred to and described. The adapter 8 is detachably inserted and fitted to the water supply opening 6, in order to prevent a fuel oil supply nozzle from being inserted by error to the water supply opening. The adapter 8 includes a cylindrical insertion fitting wall 16 formed from an appropriate resin material or the like and an annular magnet ring 18 corresponding to an automatic stop function included in a dedicated water supply nozzle.

The insertion fitting wall 16 is formed such that the outer diameter corresponds to the inner diameter of the water supply opening 6 and formed such that the inner diameter corresponds to a dedicated water supply nozzle. The outer circumferential surface of the insertion fitting wall 16 is formed with a pair of fitting pieces 20a and 20b protruding outward in the radial direction and extending in the axial direction from the upper end and a pair of fitting pieces 20c and 20d protruding outward in the radial direction and extending in the axial direction from the upper end in a position opposing the respective fitting pieces 20a and 20b across the circumferential direction center O. The fitting piece 20a and the fitting piece 20b are apart by 45 degrees in the circumferential direction. Also, the fitting piece 20c and the fitting piece 20d are apart by 45 degrees in the circumferential direction. Also, the respective fitting pieces 20a, 20b, 20c, and 20d are formed to correspond to the respective fitting grooves 12a, 12b, 12c, and 12d of the water supply opening 6.

The inner circumferential surface of the insertion fitting wall 16 is formed with a cutout 22a extending in the axial direction from the upper end and a cutout 22b extending in the axial direction from the upper end.in a position opposing the cutout 22a across the circumferential direction center O. The cutout 22a is aligned with the fitting piece 20b in terms of position in the circumferential direction. Also, the cutout 22b is aligned with the fitting piece 20d in terms of position in the circumferential direction.

Also, the inner circumferential surface of the insertion fitting wall 16 is formed with an arc-shaped engagement groove 24a extending in the circumferential direction through the lower end side of the cutout 22a and an arc-shaped engagement groove 24b extending through the lower end side of the cutout 22b. There is a fan-shaped non-groove part between the base end of the engagement groove 24a in the circumferential direction and the leading end of the engagement groove 24b in the circumferential direction. Also, there is a fan-shaped non-groove part between the base end of the engagement groove 24b in the circumferential direction and the leading end of the engagement groove 24a in the circumferential direction.

The engagement groove 24a is formed such that an engagement piece 46a described later can rotate 90 degrees in the clockwise direction in the circumferential direction from the cutout 22a when seen from above and the engagement piece 46a can rotate 45 degrees in the counterclockwise direction in the circumferential direction from the cutout 22a when seen from above. The upper surface of the engagement groove 24a is formed with a fall prevention protrusion 26a protruding downward. The fall prevention protrusion 26a is adjacent to the cutout 22a and formed on the base end side in the circumferential direction.

The engagement groove 24b is formed such that an engagement piece 46b described later can rotate 90 degrees in the clockwise direction in the circumferential direction from the cutout 22b when seen from above and the engagement piece 46b can rotate 45 degrees in the counterclockwise direction in the circumferential direction from the cutout 22b when seen from above. The upper surface of the engagement groove 24b is formed with a fall prevention protrusion 26b protruding downward. The fall prevention protrusion 26b is adjacent to the cutout 22b and formed on the base end side in the circumferential direction.

FIG. 6 to FIG. 10 will be referred to and described. The lid member 10 includes a lid body 28 that closes the water supply opening 6 and a support column 30 rotatably connected to the lid body 28.

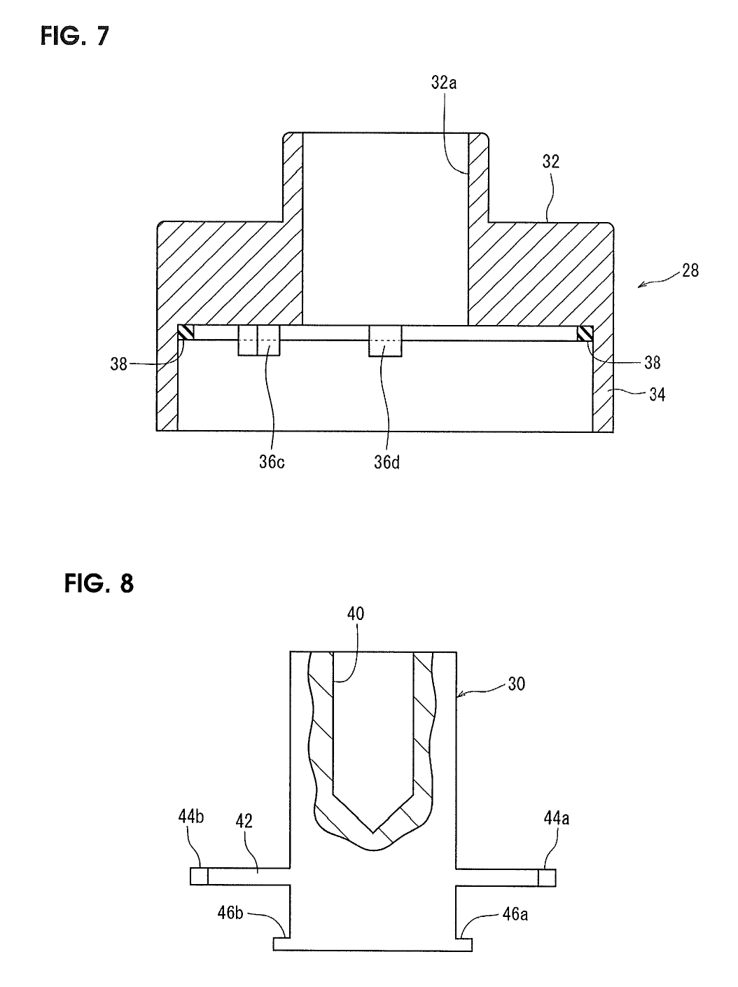

As shown in FIG. 6 and FIG. 7, the lid body 28 includes a top surface wall 32 and a cylindrical side wall 34 suspended from the outer circumferential edge of the top surface wall 32. The middle part of the top surface wall 32 is formed with a cylindrical penetration opening 32a. The outer circumferential edge side of the bottom surface of the top surface wall 32 is formed with a pair of fitting protrusions 36a and 36b extending in the axial direction and a pair of fitting protrusions 36c and 36d extending in the axial direction in a position opposing the respective fitting protrusions 36a and 36b across the circumferential direction center O. The fitting protrusion 36a and the fitting protrusion 36b are apart by 45 degrees in the circumferential direction. Also, the fitting protrusion 36c and the fitting protrusion 36d are apart by 45 degrees in the circumferential direction. That is, the respective fitting protrusions 36a, 36b, 36c, and 36d are formed to correspond to the respective fitting grooves 12a, 12b, 12c, and 12d of the water supply opening 6.

Also, the outer circumferential edge side of the bottom surface of the top surface wall 32 is arranged with a packing 38 formed from a resin material having elasticity. The packing 38 is located on the outside in the radial direction relative to the respective fitting protrusions 36a, 36b, 36c, and 36d. Upon attachment of the lid member 10 to the water supply opening 6 and the adapter 8, the packing 38 contacts the upper end surface of the water supply opening 6 to ensure water-tightness between the lid member 10 and the water supply opening 6.

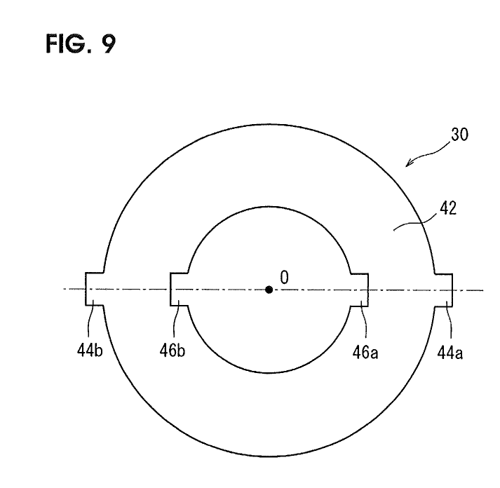

As shown in FIG. 8 and FIG. 9, the support column 30 is formed in a round column shape from a steel material and is formed with a key hole 40 extending downward from the upper end surface. The outer circumferential surface of the support column 30 is formed with an annular brim part 42 protruding outward in the radial direction and extending in the circumferential direction. The outer diameter of the brim part 42 is formed to correspond to the inner diameter of the water supply opening 6. The outer circumferential edge of the brim part 42 is formed with the locking piece 44a protruding outward in the radial direction and the locking piece 44b protruding outward in the radial direction in a position opposing the locking piece 44a across the circumferential direction center O. Also, the outer circumferential surface of the support column 30 is formed with the engagement piece 46a protruding outward in the radial direction and the engagement piece 46b protruding outward in the radial direction in a position opposing the engagement piece 46a across the circumferential direction center O.

The respective engagement pieces 46a and 46b are located below the respective locking pieces 44a and 44b. The locking piece 44a and the engagement piece 46a are aligned in terms of position in the circumferential direction. Also, the locking piece 44b and the engagement piece 46b are aligned in terms of position in the circumferential direction. The dimension in the radial direction from the leading end of the locking piece 44a in the radial direction up to the leading end of the locking piece 44b in the radial direction corresponds to the inner diameter of a portion of the inner circumferential surface of the water supply opening 6 at which the respective locking grooves 14a and 14b are formed. Also, the dimension in the radial direction from the leading end of the engagement piece 46a in the radial direction up to the leading end of the engagement piece 46b in the radial direction corresponds to the inner diameter of a portion of the inner circumferential surface of the insertion fitting wall 16 at which the respective engagement grooves 24a and 24b are formed.

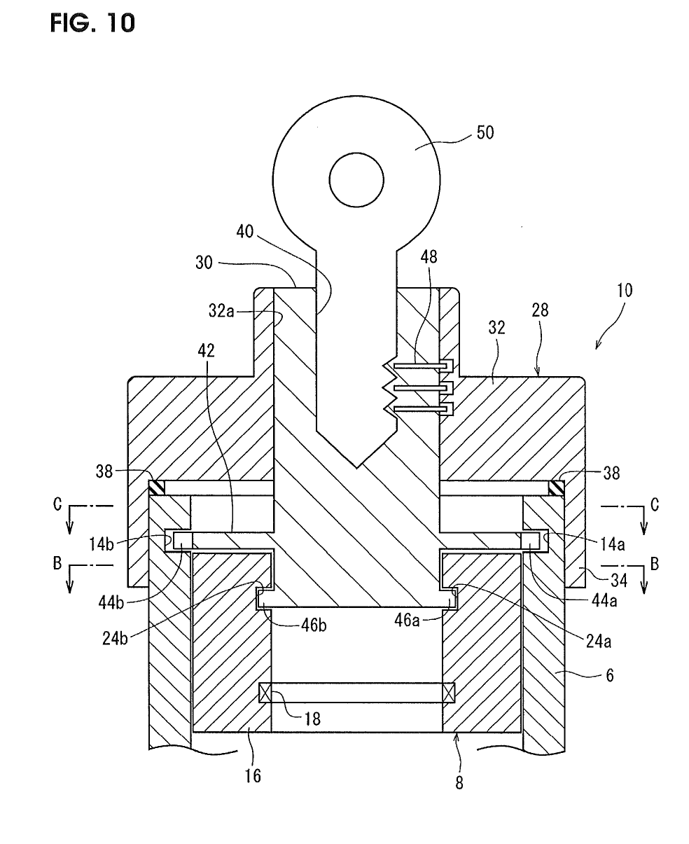

As shown in FIG. 10, the support column 30 is rotatably inserted to the penetration opening 32a of the top surface wall 32. Between the inner circumferential surface of the penetration opening 32a and the outer circumferential surface of the support column 30, a tumbler 48 that inhibits the rotation of the support column 30 with respect to the penetration opening 32a is arranged. The inhibition of relative rotation of the support column 30 by the tumbler 48 is released when a dedicated key 50 corresponding to the key hole 40 is inserted to the key hole 40. Also, when a rotating operation of the key 50 inserted to the key hole 40 is performed, the support column 30 is caused to rotate accordingly. In this manner, the lid member 10 forms a cylinder lock with the support column 30, the penetration opening 32a of the top surface wall 32, and the tumbler 48.

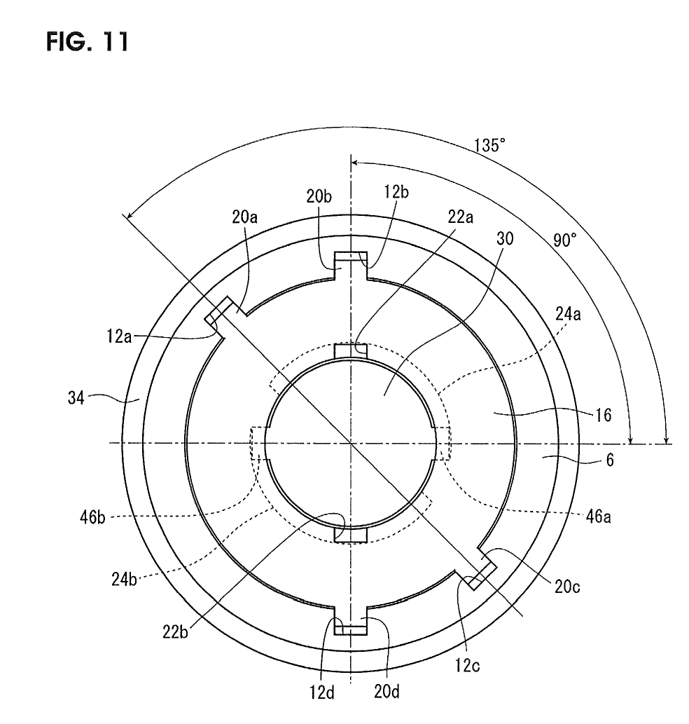

A state where the adapter 8 inserted and fitted to the water supply opening 6 and where the lid member 10 is attached to the water supply opening 6 and the adapter 8 will be described. First, regarding the adapter 8, the respective fitting pieces 20a, 20b, 20c, and 20d are fitted to the respective fitting grooves 12a, 12b, 12c, and 12d of the water supply opening 6 and inserted and fitted to the water supply opening 6, as shown in FIG. 11. Also, in a state where the adapter 8 is inserted and fitted to the water supply opening 6, the upper end surface is located below the respective locking grooves 14a and 14b of the water supply opening 6, as shown in FIG. 10.

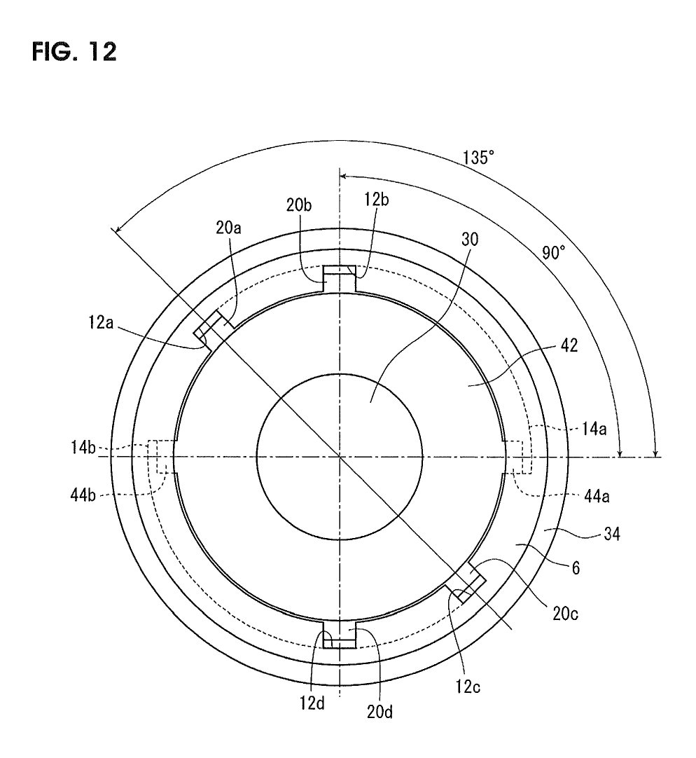

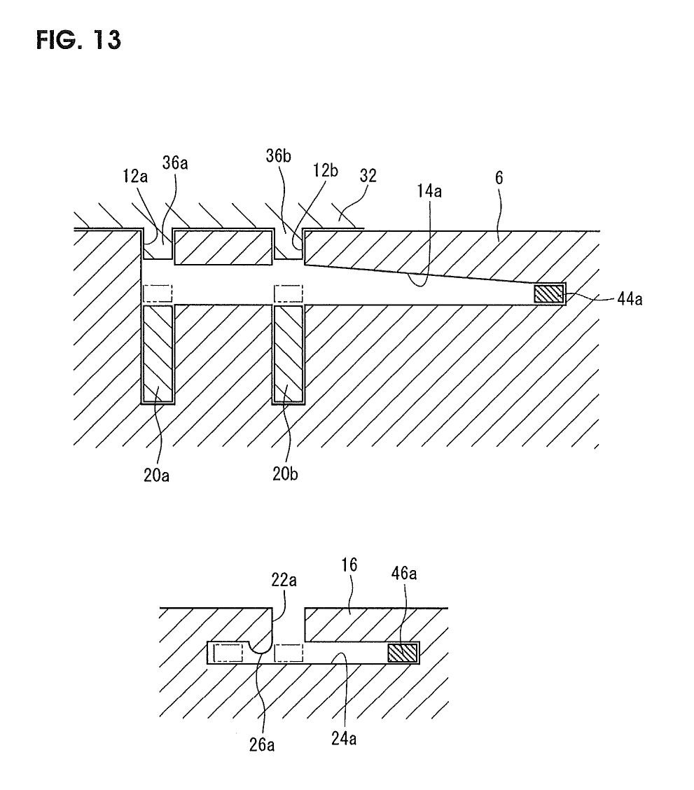

Next, regarding the lid member 10, the respective fitting protrusions 36a and 36b formed in the top surface wall 32 of the lid body 28 are fitted to the respective fitting grooves 12a and 12b, as shown in FIG. 13. Although not shown in the drawing, the respective fitting protrusions 36c and 36d are also fitted to the respective fitting grooves 12c and 12d. Also, as shown in FIG. 12 and FIG. 13, the respective locking pieces 44a and 44b of the support column 30 are locked to the respective locking grooves 14a and 14b. Herein, the locking piece 44a is in contact with the leading end of the locking groove 14a in the circumferential direction. Meanwhile, the locking piece 44b is in contact with the leading end of the locking groove 14b in the circumferential direction. Further, as shown in FIG. 11 and FIG. 13, the respective engagement pieces 46a and 46b of the support column 30 are engaged with the respective engagement grooves 24a and 24b. Herein, the engagement piece 46a is in contact with the leading end of the engagement groove 24a in the circumferential direction. Meanwhile, the engagement piece 46b is in contact with the leading end of the engagement groove 24b in the circumferential direction.

An operation upon detaching the lid member 10 from the water supply opening 6 together with the adapter 8 will be described. When the key 50 is inserted to the key hole 40 in a state where the lid member 10 is attached to the water supply opening 6 and the adapter 8, the inhibition of relative rotation of the support column 30 by the tumbler 48 is released.

Then, when a rotating operation of 135 degrees in the counterclockwise direction when seen from above is performed with respect to the key 50, the support column 30 accordingly also rotates 135 degrees in the counterclockwise direction when seen from above. Accordingly, as can be understood by referring to FIG. 12 and FIG. 13, the locking piece 44a contacts the base end of the locking groove 14a in the circumferential direction and is located at the fitting groove 12a. Also, the locking piece 44b contacts the base end of the locking groove 14b in the circumferential direction and is located at the fitting groove 12c. Thus, the locked state of the respective locking pieces 44a and 44b and the respective locking grooves 14a and 14b is released. Meanwhile, as can be understood by referring to FIG. 11 and FIG. 13, the engagement piece 46a passes through the cutout 22a and contacts the base end of the engagement groove 24a in the circumferential direction. Also, the engagement piece 46b passes through the cutout 22b and contacts the base end of the engagement groove 24b in the circumferential direction. Thus, the locked state of the respective engagement pieces 46a and 46b and the respective engagement grooves 24a and 24b is released.

Then, when the lid member 10 is forced upward, the respective locking pieces 44a and 44b ascend along the respective fitting grooves 12a and 12b, while the locked state of the respective engagement pieces 46a and 46b and the respective engagement grooves 24a and 24b is held. Therefore, the lid member 10 is detached from the water supply opening 6 together with the adapter 8 . As a result, aqueous urea can be supplied to the urea tank 2 with a general water supply nozzle.

Also, since the lid member 10 is detached together with the adapter 8 in a state where the respective engagement pieces 46a and 46b and the respective engagement grooves 24a and 24b are engaged, a situation where only the lid member 10 is attached to the water supply opening 6 without the adapter 8 being inserted and fitted to the water supply opening 6, i.e., forgetting of the insertion and fitting of the adapter 8, can be prevented from occurring. Simultaneously, loss of the adapter 8 can also be prevented. Further, since the respective engagement grooves 24a and 24b of the adapter 8 are formed with the fall prevention protrusions 26a and 26b respectively on the base end sides in the circumferential direction to be adjacent to the respective cutouts 22a and 22b, the adapter 8 detached from the water supply opening 6 together with the lid member 10 does not fall from the lid member 10.

Next, an operation upon detaching the lid member 10 from the water supply opening 6 and the adapter 8 will be described. When the key 50 is inserted to the key hole 40 in a state where the lid member 10 is attached to the water supply opening 6 and the adapter 8, the inhibition of relative rotation of the support column 30 by the tumbler 48 is released, as described above.

Then, when a rotating operation of 90 degrees in the counterclockwise direction when seen from above is performed with respect to the key 50, the support column 30 accordingly also rotates 90 degrees in the counterclockwise direction when seen from above. Accordingly, as can be understood by referring to FIG. 12 and FIG. 13, the locking piece 44a is located at the fitting groove 12b. Also, the locking piece 44b is located at the fitting groove 12d. Thus, the locked state of the respective locking pieces 44a and 44b and the respective locking grooves 14a and 14b is released. Meanwhile, as can be understood by referring to FIG. 11 and FIG. 13, the engagement piece 46a is located at the cutout 22a. Also, the engagement piece 46b is located at the cutout 22b. Thus, the engaged state of the respective engagement pieces 46a and 46b and the respective engagement grooves 24a and 24b is also released.

Then, when the lid member 10 is forced upward, the respective locking pieces 44a and 44b ascend along the respective fitting grooves 12b and 12d, and the respective engagement pieces 46a and 46b ascend along the respective cutouts 22a and 22b. Therefore, the lid member 10 is detached from the water supply opening 6 and the adapter 8. As a result, the water supply opening 6 is opened in a state where the adapter 8 is inserted and fitted to the water supply opening 6, and aqueous urea can be supplied to the urea tank 2 with a dedicated water supply nozzle.

In a manner described above, adjustment of the rotating angle of the support column 30 upon opening the water supply opening 6 in the urea tank 2 of the first embodiment enables the lid member 10 to be detached easily together with the adapter 8 from the water supply opening 6 and the lid member 10 to be detached easily from the water supply opening 6 and the adapter 8.

Also, the urea tank 2 of the first embodiment can satisfy the specification in ISO 22241-4:2009 or JIS K 2247-4:2013 that “a filler neck (water supply opening 6) installed with an inlet adapter (adapter 8) has a structure that allows a vehicle manufacturer or any authorized person to install or remove the inlet adapter (adapter 8) , ” since the lid member 10 forms a cylinder lock with the support column 30, the penetration opening 32a of the top surface wall 32, and the tumbler 48.

Further, in the urea tank 2 of the first embodiment, the respective fitting protrusions 36a, 36b, 36c, and 36d formed at the bottom surface of the top surface wall 32 of the lid body 28 is caused to fit to the respective fitting grooves 12a, 12b, 12c, and 12d of the water supply opening 6. Therefore, upon attaching the lid member 10 to the water supply opening 6 and the adapter 8, the attachment is not made with the lid member 10 being in an erroneous position in the circumferential direction.

In the first embodiment, description has been given, assuming that the rotating angle of the support column 30 upon detaching the lid member 10 together with the adapter 8 from the water supply opening 6 is 135 degrees from the attached state, and assuming that the rotating angle of the support column 30 upon detaching the lid member 10 from the water supply opening 6 and the adapter 8 is 90 degrees from the attached state. However, the respective rotating angles are not limited as such and can be set arbitrarily.

Also, in the first embodiment, description has been given, assuming that there are two pairs of the fitting grooves and two locking grooves of the water supply opening, two pairs of the fitting pieces and two each of the cutouts and the engagement grooves of the insertion fitting wall, two pairs of the fitting protrusions of the lid member, and two each of the locking pieces and the engagement pieces of the support column. However, there may be one pair of the fitting grooves and one locking groove of the water supply opening, one pair of the fitting pieces and one each of the cutout and the engagement groove of the insertion fitting wall, one pair of the fitting protrusions of the lid member, and one each of the locking piece and the engagement piece of the support column. For example, such a case is where there are one pair of the fitting grooves 12a and 12b and one locking groove 14a of the water supply opening, one pair of the fitting pieces 20a and 20b, one cutout 22a, and one engagement groove 24a of the insertion fitting wall, one pair of the fitting protrusions 36a and 36b of the lid body, and one locking piece 44a and one engagement piece 46a of the support column.

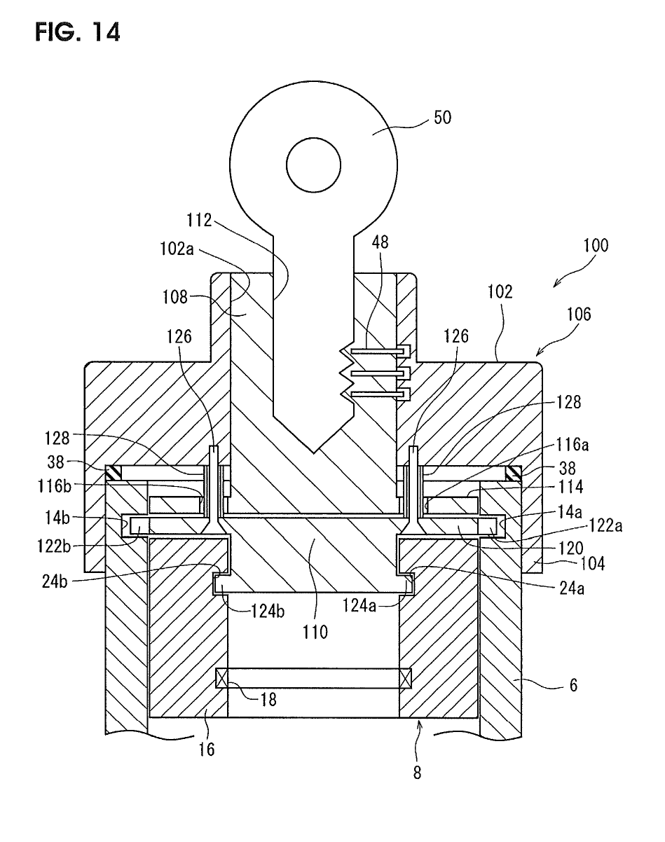

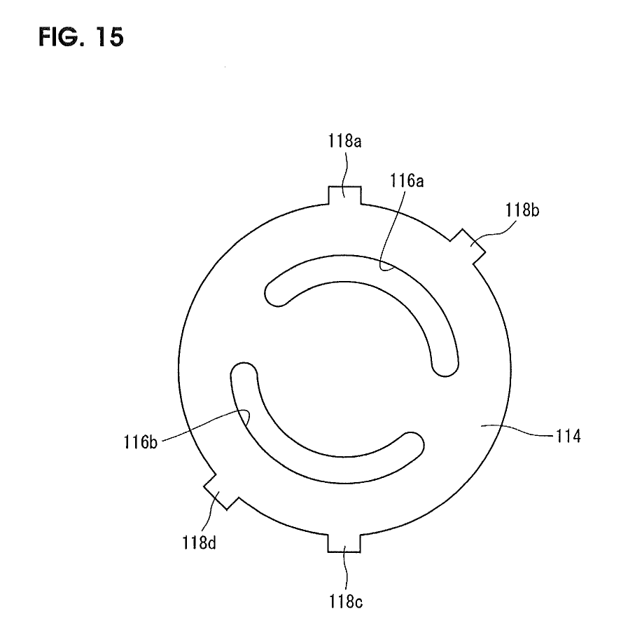

A second embodiment of a urea tank according to the present invention will be described with reference to FIG. 14 and FIG. 15. In the second embodiment, the same components as in the first embodiment described above will be denoted by the same reference numerals, and description thereof will be omitted.

As shown in FIG. 14, a lid member 100 is configured of a lid body 106 including a top surface wall 102 formed with a penetration opening 102a and a cylindrical side wall 104, an upper part support column 108 connected to the top surface wall 102 to be relatively rotatable, and a lower part support column 110 fastened to the top surface wall 102.

The upper part support column 108 is formed with a key hole 112 extending downward from the upper end surface and a flange part 114 protruding outward in the radial direction from the outer circumferential surface on the lower end side. As shown in FIG. 15, the flange part 114 is formed with a pair of arc-shaped cutouts 116a and 116b penetrating in the axial direction and four whirl-stop pieces 118a, 118b, 118c, and 118d protruding outward in the radial direction from the outer circumferential surface.

In a state where the lid member 100 is attached to the water supply opening 6 and the adapter 8, the rotation of the upper part support column 108 in the circumferential direction is inhibited by the respective whirl-stop pieces 118a, 118b, 118c, and 118d being fitted to the respective fitting grooves 12a, 12b, 12c, and 12d of the water supply opening 6. Also, the tumbler 48 is arranged between the inner circumferential surface of the penetration opening 102a of the top surface wall 102 and the outer circumferential surface of the upper part support column 108 to inhibit the relative rotation of the top surface wall 102 and the upper part support column 108.

The lower part support column 110 is formed with a brim part 120 protruding outward in the radial direction from the outer circumferential surface on the upper end side, a pair of locking pieces 122a and 122b, and a pair of engagement pieces 124a and 124b. Also, an internal thread is formed at the bottom surface of the top surface wall 102, a circular hole is formed at the brim part 120 of the lower part support column 110, and the lid body 106, the upper part support column 108, and the lower part support column 110 are fastened by bolts 126. Herein, in the respective arc-shaped cutouts 116a and 116b, cylindrical spacers 128 with a larger dimension in the axial direction than the thickness dimension of the flange part 114 are placed.

When the dedicated key 50 is inserted to the key hole 112 in a state where the lid member 100 is attached to the water supply opening 6 and the adapter 8, the inhibition of relative rotation of the lid body 106 and the upper part support column 108 by the tumbler 48 is released. Then, when a rotating operation of 135 degrees in the counterclockwise direction when seen from above is performed with respect to the lid body 106, the lower part support column 110 accordingly also rotates 135 degrees in the counterclockwise direction when seen from above. Accordingly, the locked state of the respective locking pieces 122a and 122b and the respective locking grooves 14a and 14b is released, but the engaged state of the respective engagement pieces 124a and 124b and the respective engagement grooves 24a and 24b is held. Then, when the lid member 100 is forced upward, the respective locking pieces 122a and 122b ascend along the respective fitting grooves 12a and 12c, but the engaged state of the respective engagement pieces 124a and 124b and the respective engagement grooves 24a and 24b is held. Therefore, the lid member 100 is detached from the water supply opening 6 together with the adapter 8. As a result, aqueous urea can be supplied to the urea tank 2 with a general water supply nozzle.

Meanwhile, when a rotating operation of 90 degrees in the counterclockwise direction when seen from above is performed with respect to the lid body 106 after the inhibition of relative rotation of the lid body 106 and the upper part support column 108 by the tumbler 48 has been released, the lower part support column 110 accordingly also rotates 90 degrees in the counterclockwise direction when seen from above. Accordingly, the locked state of the respective locking pieces 122a and 122b and the respective locking grooves 14a and 14b is released, and the engaged state of the respective engagement pieces 124a and 124b and the respective engagement grooves 24a and 24b is also released. Then, when the lid member 100 is forced upward, the respective locking pieces 122a and 122b ascend along the respective fitting grooves 12b and 12d, and the respective engagement pieces 124a and 124b ascend along the respective cutouts 22a and 22b. Therefore, the lid member 100 is detached from the water supply opening 6 and the adapter 8. As a result, the water supply opening 6 is opened in a state where the adapter 8 is inserted and fitted to the water supply opening 6, and aqueous urea can be supplied to the urea tank 2 with a dedicated water supply nozzle.

In a manner described above, adjustment of the rotating angle of the lid body 106 upon opening the water supply opening 6 in the urea tank of the second embodiment enables the lid member 100 to be detached easily together with the adapter 8 from the water supply opening 6 and the lid member 100 to be detached easily from the water supply opening 6 and the adapter 8.

In the second embodiment, description has been given on the lid member 100 in which the lid body 106, the upper part support column 108, and the lower part support column 110 are configured separately. However, the lid member may be such that the lid body, the upper part support column, and the lower part support column are configured integrally. Also, in the second embodiment, rotation inhibiting means for inhibiting the relative rotation of the lid member with respect to the water supply opening is not limited to being configured of the whirl-stop piece of the upper part support column and the cylinder lock as described above. For example, the relative rotation of the lid member with respect to the water supply opening may be inhibited by arranging a gate and a padlock between the lid member and the water supply opening. In this case, the relative rotation of the lid member with respect to the water supply opening is released by a releasing operation of a key corresponding to the padlock.

### EXPLANATION OF REFERENCE NUMERALS

2: Urea tank

6: Water supply opening

8: Adapter

10: Lid member

12a, 12b, 12, 12d: Fitting groove

14a, 14b: Locking groove

16: Insertion fitting wall

20a, 20b, 20c, 20d: Fitting piece

22a, 22b: Cutout

24a, 24b: Engagement groove

28: Lid body

30: Support column

32: Top surface wall

32a: Penetration opening

34: Side wall

36a, 36b, 36c, 36d: Fitting protrusion

40: Key hole

44a, 44b: Locking piece

46a, 46b: Engagement piece

48: Tumbler

50: Key

1. A urea tank comprising:
a cylindrical water supply opening;
an adapter inserted and fitted to the water supply opening; and
a lid member attached to the water supply opening and the adapter,
wherein an inner circumferential surface of the water supply opening is formed with at least a pair of fitting grooves extending in an axial direction from an upper end, and a locking groove extending in a circumferential direction from one of the pair of fitting grooves and extending through the other one of the pair of fitting grooves,
the adapter includes a cylindrical insertion fitting wall, an outer circumferential surface of the insertion fitting wall is formed with at least a pair of fitting pieces protruding outward in a radial direction, and the adapter is inserted and fitted to the water supply opening and located below the locking groove by one of the pair of fitting pieces being fitted to one of the pair of fitting grooves and the other one of the pair of fitting pieces being fitted to the other one of the pair of fitting grooves,
an inner circumferential surface of the insertion fitting wall is formed with at least one cutout extending in an axial direction from an upper end and an engagement groove extending in a circumferential direction through the cutout, the cutout being aligned with the other one of the pair of fitting pieces in terms of position in a. circumferential direction,
the lid member includes a lid body including a top surface wall and a cylindrical side wall suspended from a circumferential edge of the top surface wail, and a support column. extending downward from the top surface wall,
the support column is formed with at least one locking piece protruding outward in a radial direction from an outer circumferential surface and at least one engagement piece protruding outward in the radial direction from the outer circumferential surface and located below the locking piece, the locking piece and the engagement piece being aligned in terms of position in a circumferential direction,
the lid member is attached to the water supply opening and the adapter by the locking piece being locked to the locking groove of the water supply opening and the engagement piece being engaged with the engagement groove of the adapter,
the lid member is detached from the water supply opening together with the adapter, when the lid member is rotated until the locking piece is located at one of the pair of fitting grooves and then forced upward in a state where the lid member is attached to the water supply opening and the adapter, and
the lid member is detached from the water supply opening and the adapter, when the lid member is rotated until the locking piece is located at the other one of the pair of fitting grooves and then forced upward in a state where the lid member is attached to the water supply opening and the adapter.

2. The urea tank according to claim 1, wherein the support column is rotatably connected to the top surface wall.

3. The urea tank according to claim 2,
wherein a cylindrical penetration opening is formed in the top surface wall of the lid body, the support column is formed in a cylindrical shape and rotatably inserted to the penetration opening, and a tumbler that inhibits rotation of the support column with respect to the penetration opening is arranged between an inner circumferential surface of the penetration opening and the outer circumferential surface of the support column, and
the support column is formed with a key hole extending downward from an upper end surface, inhibition of relative rotation of the support column by the tumbler is released when a key corresponding to the key hole is inserted to the key hole, and the support column is rotated by a rotating operation of the key.

4. The urea tank according to claim 2, wherein a bottom surface of the top surface wall of the lid body is formed with at least one pair of fitting protrusions protruding downward, and the fitting protrusions are fitted to the fitting grooves of the water supply opening, respectively, in a state where the lid member is attached to the water supply opening and the adapter.

5. The urea tank according to claim 1, wherein rotation inhibiting means for inhibiting relative rotation of the lid member with respect to the water supply opening is arranged between the lid member and the water supply opening, and inhibition of relative rotation of the lid member by the rotation inhibiting means is released by releasing means corresponding to the rotation inhibiting means.

6. The urea tank according to claim 3, wherein a bottom surface of the top surface wall of the lid body is formed with at least one pair of fitting protrusions protruding downward, and the fitting protrusions are fitted to the fitting grooves of the water supply opening, respectively, in a state where the lid member is attached to the water supply opening and the adapter.
